(19) United States
(12) Patent Application Publication
(10) Pub. No.: US 2005/0191485 A1
(43) Pub. Date: Sep. 1, 2005

(54) Film and adhesive therefor

(75) Inventors: Hideki Kitano, Kodaira-shi (JP); Kiyomi Sasaki, Kodaira-shi (JP); Kenji Murayama, Kodaira-shi (JP); Hidefumi Kotsubo, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/102,778

(22) Filed: Apr. 11, 2005

Related U.S. Application Data
(63) Continuation of application No. PCT/JP03/12876, filed on Oct. 8, 2003.

(30) Foreign Application Priority Data
Oct. 17, 2002 (JP) 2002-303350
Oct. 17, 2002 (JP) 2002-303351
Jan. 10, 2003 (JP) 2003-004721
Sep. 3, 2003 (JP) 2003-311574

(51) Int. Cl. B32B 7/12; G03B 17/26

(52) U.S. Cl. 428/343; 428/354; 428/355 AC

(57) ABSTRACT

An adhesion-including film is provided, wherein the total light transmittance is varied in a width direction of the film. The adhesion-including film includes a mold release film, a first adhesive layer disposed on this mold release film, a second adhesive layer disposed on the first adhesive layer, a base film on the second adhesive layer, and an antireflection film disposed on the film surface opposite to the second adhesive layer of the base film. The first adhesive layer is highly colored as compared with the second adhesive layer. The second adhesive layer may be colorless. The thickness of the central portion of the first adhesive layer in the width direction of the film is larger than the thicknesses of both end sides. The total thickness of the first adhesive layer and the second adhesive layer is uniform all over the film.

### CROSS REFERENCE TO RELATED APPLICATION

This is a continuation application of PCT/JP03/12876 filed on Oct. 8, 2003.

### BACKGROUND OF THE INVENTION

1. Field of the Invention

I. An aspect of the present invention relates to a film and a method for manufacturing the film. In particular, it relates to a film suitable for electronic displays, e.g., liquid crystal displays, and to a method for manufacturing the film.

II. Another aspect of the present invention relates to a dimmer film and a method for manufacturing the dimmer film. In particular, it relates to a dimmer film suitable for electronic displays, e.g., liquid crystal displays, and having a light transmission property with the total light transmittance being varied in a surface direction, and to a method for manufacturing the dimmer film.

III. Another aspect of the present invention relates to an adhesive to stick a functional film, e.g., an antireflection film, on a front panel of a display, e.g., a plasma display or a liquid crystal display, and to a functional film provided with an adhesive layer made of this adhesive. In particular, it relates to a display adhesive exhibiting high adhesion to a display panel and having the adhesion and optical properties exhibiting excellent high-temperature durability and high-humidity durability and to a display functional film.

2. Description of the Related Art

I. Light sources are required to display letters and images on liquid crystal displays. In recent years, thicknesses of displays have been reduced. Consequently, the light from the light source is incident from one side surface or two side surfaces. Now, the light is scattered by using a light guide plate, a diffusion film, and the like so that the light reaches the front of the display panel.

In order to prevent damage to the display panel and improve viewability, a functional light transmission film is stuck on a front panel. An adhesive is adhered to this film, and the film is stuck by this adhesive layer (for example, Japanese Unexamined Patent Application Publication No. 2002-107507).

The uniformity of the luminance of the display panel is not perfect, and variations in luminance may occur. In particular, as the display is upsized, variations in luminance tend to become conspicuous. As for the above-described variations in luminance, in general, the luminance is decreased with distance from the light source. However, sometimes, the luminance is decreased as the light source approaches, or is varied, such as dark-bright-dark, depending on the configuration of the light guide plate. In many cases, variations in luminance are generally in such a manner that the luminance is varied in a direction of a straight line. In some type of display, a phenomenon occurs, in which the luminance of the central portion of a screen is high, but the luminance of the perimeter is low.

II. Various functional light transmission films, e.g., a film provided with a hard coat layer, a transparent electrically conductive layer, an antiglare layer, an antireflection layer, and the like on one surface of a light transmission film, are attached to front panels (display panels) of various electronic displays, e.g., plasma displays and liquid crystal displays, for the purpose of providing functionality, e.g., antireflection property and antiglare property.

In general, various electronic display panels are composed of hard sheets, e.g., glass sheets, acrylic sheets, and polycarbonate sheets, having thicknesses of about 1 to 10 mm. Functional light transmission films, e.g., antireflection films, are stuck to these various electronic display panels with adhesives.

Various adhesives of, e.g., rubber base, acryl base, and silicone base, have been previously provided as the adhesives used for sticking these functional light transmission films in accordance with the material systems. Among them, acrylic adhesives are most suitable as display adhesives required to have high optical performances.

However, with respect to known acrylic adhesives, there is a problem of reduction in adhesion or deterioration, e.g., yellowing, under a specific use environment. That is, for example, there are problems of peeling of a functional light transmission film due to reduction in adhesion and deterioration of transparency due to yellowing of the adhesive because of a high humidity condition, an occurrence of an external factor of heating, or an occurrence of abnormal internal heat generation.

### SUMMARY OF THE INVENTION

I. It is a first object of the present invention to provide a light transmission film capable of overcoming the above-described problems in the background art I and eliminating or suppressing variations in luminance of a display panel, as well as a method for manufacturing the same.

A light transmission film according to an aspect of the present invention is characterized in that the total light transmittance is varied in a transverse direction of the film.

This film can exhibit a distribution of light and dark which is the reverse of high and low of the luminance in accordance with variations in luminance of the display. This film is stuck to the display and, thereby, variations in luminance of the display can be eliminated or suppressed.

The total light transmittance of the film may be varied not only in the transverse direction, but also in the direction orthogonal to the transverse direction. That is, the total light transmittance may be varied not only in a one-dimensional direction, but also in a two-dimensional direction.

In order to vary the total light transmittance of the film in a one-dimensional direction or a two-dimensional direction, in the case where the film includes a base film and a colored adhesive layer, the total light transmittance of this adhesive layer may be varied in a one-dimensional direction or a two-dimensional direction. The total light transmittance of the adhesive layer can be varied in a one-dimensional direction or a two-dimensional direction by changes in the thickness or the color strength of the adhesive layer.

The total light transmittance of the film can also be varied in a one-dimensional direction or a two-dimensional direction by forming a colored layer other than the adhesive layer on the base film and changing the thickness or the color strength of this colored layer. This colored layer may be a functional layer, e.g., an antireflection layer, a hard coat layer, an antiglare layer, or an electrically conductive layer. The color may be either a chromatic color or an achromatic color.

In the case where the base film itself which constitutes the film is colored, the total light transmittance of the film may be varied in a one-dimensional direction or a two-dimensional direction by changing the thickness or the color strength of this base film.

This film can be used not only for liquid crystal displays of back light system or front light system, but also for other displays, e.g., CRT, PDP, and FED. This film can also be used for display panels, e.g., electric bulletin boards, having light sources.

According to another aspect of the present invention, a method for manufacturing an adhesive-including film, including the step of supplying an adhesive on a film surface to form an adhesive layer on the film surface while the film is continuously forwarded, is provided. The method includes the step of forming the adhesive layer so that the thickness of the adhesive layer is varied in a film width direction orthogonal to the forwarding direction of the film.

A method in which all materials are homogeneously mixed, kneading is performed with an extruder, rolls, or the like and, thereafter, a film in a predetermined shape is formed by a film formation method, e.g., calender rolling, T die extrusion, or inflation, can be used as the method for forming (a film of) an adhesive layer on a film. For example, in the T die extrusion, the thickness of the formed film is varied in one direction (transverse direction) by changing the thickness of an extrusion hole. Consequently, the total light transmittance is varied. In addition, a film can also be formed by a method in which all constituents are homogeneously mixed and dissolved into a good solvent, the resulting solution is applied to a support, a separator made of a precise coating of silicone or fluororesin, by a flow coating method, a roll coating method, a gravure roll method, a meyer bar method, a lip die coating method, or a comma method, and the solvent is removed by drying. At that time, in order to change the thickness of the formed film in a direction perpendicular to the coating direction, for example, in the comma method, a gap between a roll and a knife is changed in the perpendicular direction by providing curving. Consequently, the thickness after drying is varied.

II. It is a second object of the present invention to provide a dimmer film capable of overcoming the above-described problems in the background art I and having a light transmission property with the total light transmittance being varied in a surface direction, wherein a desired transmitted color can be readily attained, as well as a method for manufacturing the same.

A dimmer film according to another aspect of the present invention includes a base film, a colored layer disposed on the base film, and an adhesive layer disposed on the colored layer and has a light transmission property with the total light transmittance being varied in a surface direction due to changes in the color strength of the colored layer in the surface direction, wherein the colored layer contains a heat-resistant dye readily fading due to ultraviolet light B, the colored layer has been faded by being irradiated with the ultraviolet light B having a light quantity distribution in the surface direction so that the color strength is varied in the surface direction, and the adhesive layer contains a pigment.

A method for manufacturing a dimmer film including a base film, a colored layer disposed on the base film, and an adhesive layer disposed on the colored layer and having a light transmission property with the total light transmittance being varied in a surface direction of the film, according to another aspect of the present invention, includes the steps of forming the colored layer on a substrate, the colored layer containing a heat-resistant dye readily fading due to ultraviolet light B, in a first step; irradiating the colored layer with the ultraviolet light B through a mask having an ultraviolet light B transmission quantity distribution in the surface direction so that the colored layer is faded and the color strength is varied in the surface direction, in a second step; and thereafter, forming the adhesive layer on the colored layer, the adhesive layer containing a pigment, in a third step.

The dimmer film having the total light transmittance being varied in a surface direction can be produced by irradiating the colored layer with the ultraviolet light B having a light quantity distribution in the surface direction so that the colored layer is faded and the color strength is varied in the surface direction, the colored layer containing a heat-resistant dye readily fading due to the ultraviolet light B. Since the adhesive layer containing the pigment is formed on this colored layer, the transmitted color of the dimmer film can be arbitrarily adjusted to become a desired color tone by the pigment in the adhesive layer.

The dimmer film having the total light transmittance being varied in a surface direction may be produced by only a colored layer having the color strength being varied in the surface direction. However, in this case, the transmitted color of the dimmer film becomes equal to the transmitted color of the base film depending on the degree of fading of the colored layer, and it is difficult to attain a desired transmitted color. In the present invention, since the adhesive layer containing a pigment is disposed on this colored layer, the transmitted color of the dimmer film can be arbitrarily adjusted to a desired color tone.

In the present invention, preferably, the mask having an ultraviolet light B transmission quantity distribution in the surface direction is made of a polyethylene terephthalate (PET) film, and has the ultraviolet light B transmission quantity distribution due to changes of the thickness in the surface direction.

Preferably, the colored layer is a colored adhesive layer. The colored layer may be a part of an antireflection layer, a hard coat layer, an antiglare layer, or an electrically conductive layer. Preferably, the colored layer is formed by gravure coating.

In the dimmer film according to an aspect of the present invention and the dimmer film manufactured by the method according to another aspect of the present invention, the total light transmittance of the central portion in the transverse direction of the dimmer film may be lower than those of both end sides, and the distribution of the total light transmittance in the direction orthogonal to the transverse direction of the dimmer film may be uniform.

In the dimmer film, the total light transmittance may be varied in the direction orthogonal to the transverse direction of the dimmer film.

According to the dimmer film of the present invention and the manufacturing method therefor, a dimmer film having a light transmission property with the total light transmittance being varied in a surface direction and a desired transmitted color can be readily attained.

III. It is a third object of the present invention to provide a display adhesive capable of overcoming the above-described problems in the background art II and having high adhesion to various display panels while the adhesion and optical properties exhibit excellent high-temperature durability and high-humidity durability, as well as a display functional film including this adhesive.

A display adhesive according to another aspect of the present invention contains a (meth)acrylic resin as a primary component and a cross-linking agent, wherein the (meth)acrylic resin contains 1 to 25 percent by weight of monomer component having a carboxyl group, as a copolymerization component of the alkyl(meth)acrylate, and the cross-linking agent is an epoxy compound.

The term “(meth)acrylic” refers to “acrylic and/or methacrylic”, and the term “(meth)acrylate” refers to “acrylate and/or methacrylate”.

This adhesive has high adhesion, excellent heat resistance, and excellent humidity resistance since a primary component is the (meth)acrylic resin containing the monomer component having a carboxyl group, and the cross-linking agent is contained. Furthermore, the cross-linking agent is the epoxy compound having very high thermal stability and, thereby, significantly high effect is exerted on improvement of the heat resistance.

Preferably, the weight average molecular weight of the (meth)acrylic resin is 500,000 to 2,000,000. Preferably, the monomer component having a carboxyl group is at least one selected from the group consisting of (meth)acrylic acid, carboxyethyl(meth)acrylate, carboxypentyl(meth)acrylate, itaconic acid, maleic acid, and crotonic acid. Preferably, the content of the cross-linking agent is 0.5 to 50 percent by weight relative to the above-described monomer component having a carboxyl group.

A display functional film according to another aspect of the present invention include an adhesive layer on one surface of a base film, the adhesive layer being made of the display adhesive according to the above-described aspect of the present invention. The display functional film has high adhesion to display panels and excellent optical properties, each exhibiting excellent high-temperature durability and high-humidity durability.

In this display functional film, usually, at least one selected from the group consisting of a hard coat layer, a transparent electrically conductive layer, an antiglare layer, and an antireflection layer is disposed on the other surface of the base film.

### BRIEF DESCRIPTION OF THE DRAWINGS

FIG. 1 is a sectional view of an adhesive-including film according to an embodiment.

FIGS. 2A and 2B are sectional views showing a method for manufacturing an adhesive-including film according to an embodiment.

FIG. 3 is a sectional view showing a method for manufacturing an adhesive-including film according to an embodiment.

FIG. 4A is a sectional view showing a method for manufacturing an adhesive-including film according to an embodiment, and FIG. 4B is a diagram showing the shape of a blade.

FIG. 5 is a perspective view showing a method for manufacturing an adhesive-including film according to an embodiment.

FIG. 6 is a sectional view showing a method for manufacturing an adhesive-including film according to an embodiment.

FIG. 7 is a sectional view showing a method for manufacturing an adhesive-including film according to an embodiment.

FIG. 8A is a vertical sectional view showing a method for manufacturing an adhesive-including film according to another embodiment. FIG. 8B is a sectional view of the section indicated by a line VIIIb-VIIIb shown in FIG. 8A. FIG. 8C is a sectional view of the section indicated by a line VIIIc-VIIIc shown in FIG. 8B.

FIGS. 9A to 9E are sectional views showing an embodiment of a method for manufacturing a dimmer film according to the present invention.

FIG. 10 is a sectional view showing an embodiment of a display functional film according to the present invention.

### DESCRIPTION OF THE PREFERRED EMBODIMENTS

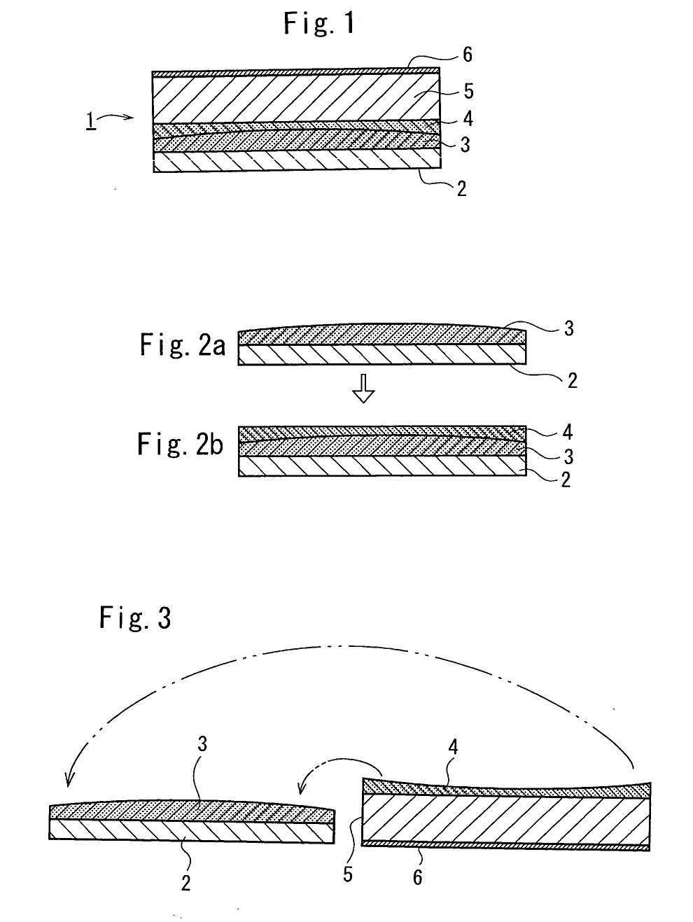

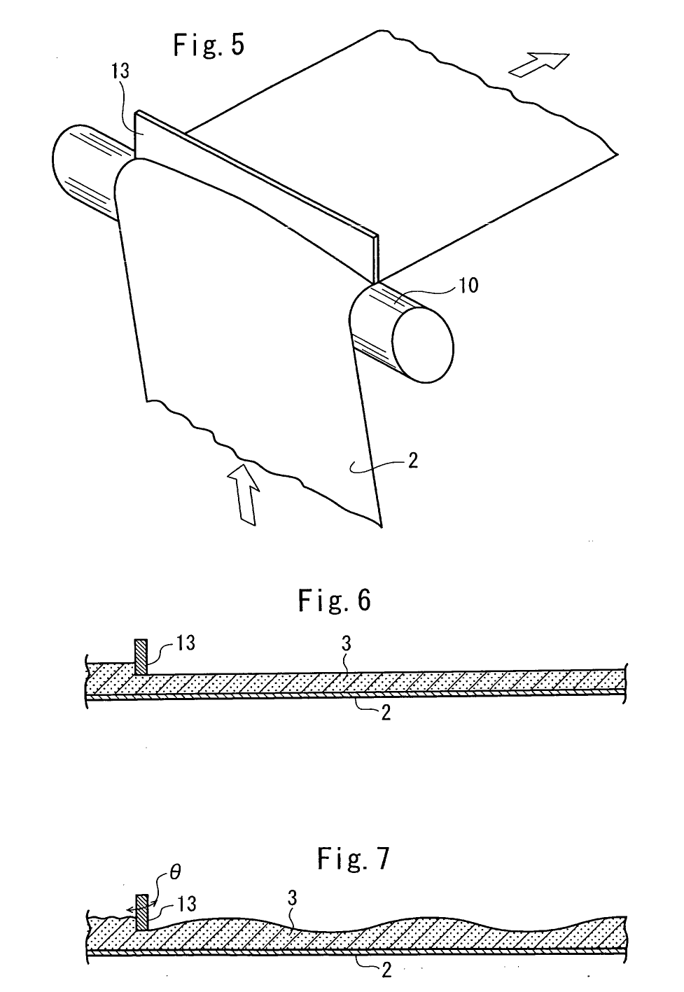

I. Embodiment will be described below with reference to the drawings. FIG. 1 is a sectional view in the film width direction of an adhesive-including film according to an embodiment. FIG. 2 to FIG. 8C are explanatory diagrams of manufacturing methods therefor.

This adhesive-including film 1 includes a mold release film 2, a first adhesive layer 3 disposed on this mold release film 2, a second adhesive layer 4 disposed on the first adhesive layer, a base film 5 on the second adhesive layer, and an antireflection film 6 disposed on the film surface opposite to the second adhesive layer 4 of the base film 5.

In the present embodiment, the first adhesive layer 3 is highly colored as compared with the second adhesive layer 4. The second adhesive layer 4 may be colorless. The thickness of the first adhesive layer 3 is varied in the width direction of the film 1. In the present embodiment, the thickness of the central portion of the first adhesive layer 3 in the width direction of the film is larger than the thicknesses of both end sides. The total thickness of the first adhesive layer 3 and the second adhesive layer 4 is uniform all over the film.

In the case where the uniformity of the thickness of the adhesive layer is unnecessary, the second adhesive layer may not be disposed.

The film 1 is long-extended in a direction orthogonal to the width direction (direction perpendicular to the drawing in FIG. 1). The thickness of the first adhesive layer 3 may be uniform or periodically changed in the longitudinal direction of the film.

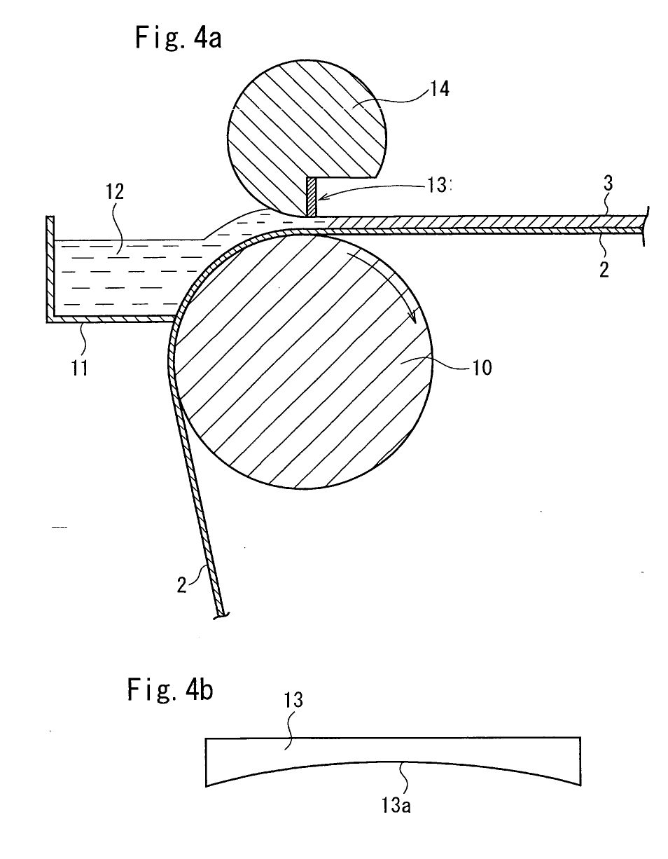

A method for manufacturing this first adhesive layer 3 on a mold release film will be described with reference to FIG. 4 to FIG. 7.

As shown in FIG. 4A, the mold release film 2 is looped over an application roll 10 and is forwarded continuously. The direction of the center of axis of this application roll 10 is set in the horizontal direction. A liquid dam 11 is disposed adjacent to this application roll 10, and a coating solution 12 held in the liquid dam 11 is in contact with the film surface of the mold release film 2.

As the film 2 is forwarded, the coating solution 12 is adhered to the film surface and is pulled up. The coating solution 12 pulled up while being adhered to this film 2 is scraped and leveled with a blade 13, so that the first adhesive layer 3 is formed.

This blade 13 is attached to a comma 14. In the present embodiment, as shown in FIG. 4B, the lower edge of the blade 13 has the form of an arch surface 13a curved to become convex upward in the width direction of the film 2. Consequently, the clearance between the blade 13 and the film 12 reaches a maximum value at the central portion of the width direction of the film 2 and decreases with increasing proximity to both end sides of the film 2. Since the coating solution 12 on the film 2 is leveled with this blade 13, the thickness of the adhesive layer 3 disposed on the film 2 reaches a maximum at the central portion in the width direction of the film 2 and decreases with increasing proximity to both end sides.

In order to complete the film 1, the second adhesive layer 4 may be formed on the first adhesive layer 3, as shown in FIGS. 2A and 2B, and the base film 5 may be stacked thereon. Alternatively, the second adhesive layer 4 may be formed on the base film 5, and the mold release film 2 provided with the first adhesive layer 3 and the base film 5 provided with the second adhesive layer 4 may be stacked, as shown in FIG. 3. The thickness of the second adhesive layer 4 shown in FIG. 3 decreases with increasing proximity to the central portion in the width direction of the film 5. The above-described second adhesive layer 4 may be formed on the film 5 by using a blade curved to become convex downward, for example.

As described above, the first adhesive layer 3 of the film 1 is highly colored as compared with the second adhesive layer 4. Therefore, the film 1 is most highly colored (the total light transmittance is low.) at the central portion in the width direction, and becomes lightly colored with increasing proximity to both end sides. That is, the total light transmittance of the film 1 is increased with increasing proximity to both end sides in the width direction.

Consequently, in the case where the mold release film 2 is peeled off and the film 1 is stuck to a display, when variations in luminance of the display is in a pattern reverse to the distribution of light and dark of the film 1, the variations in luminance can be eliminated or reduced.

By making the blade 13 stand still as shown in FIG. 6, the thickness of the first adhesive layer 3 is made uniform in the longitudinal direction of the film 2. By shaking the blade 13 in the direction indicated by an arrow θ as shown in FIG. 7, the thickness of the first adhesive layer 3 is periodically varied in the longitudinal direction of the film 2. In the case where the configuration shown in FIG. 7 is adopted, an adhesive-including film, in which dark and light are periodically varied not only in the width direction of the film 1, but also in the direction orthogonal thereto, is produced.

In FIG. 7, the lower edge side of the blade 13 is shaken. However, the thickness of the first adhesive layer 3 can also be periodically varied in the longitudinal direction of the film 2 by shaking the upper edge side of the blade 13. The thickness of the first adhesive layer 3 can also be periodically varied in the longitudinal direction of the film 2 by periodically moving the blade 3 up or down.

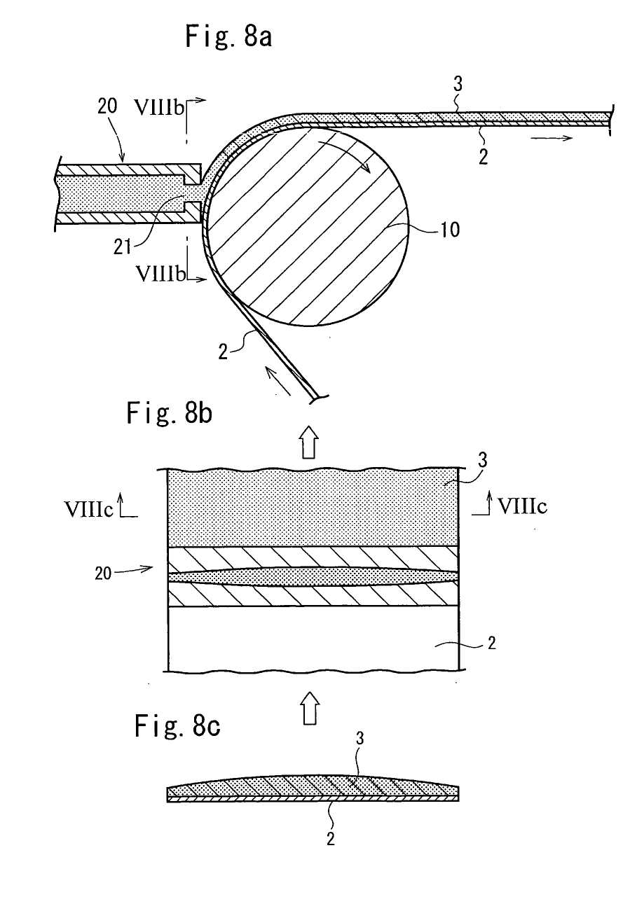

Although the blade is used in FIG. 7, the thickness of the first adhesive layer 3 may also be varied in the longitudinal direction of the film 2 by using a lip die 20 as shown in FIG. 8A. The lips 21 of this lip die 20 have a large width of the opening at the center in the width direction, and the width of the opening decreases with increasing proximity to both end sides in the width direction, as shown in FIG. 8B. In this manner, as shown in FIG. 8C, the thickness of the first adhesive layer 3 reaches a maximum at the center in the width direction, and the thickness decreases with increasing proximity to both end sides.

In the cases shown in FIGS. 8A to 8C, when the quantity of discharge of the coating solution from the lip die 20 is made constant with time, the thickness of the adhesive layer 3 becomes uniform in the forwarding direction of the film 2. When the above-described quantity is periodically increased and decreased, the thickness is periodically varied in the forwarding direction.

The thickness distribution of the adhesive layer 3 in the film width direction in the above-described embodiment is an example of aspects of the present invention, and the thickness distribution is not limited to this. For example, the thickness of the adhesive layer 3 may also be periodically varied in the film width direction.

According to the present invention, a film exhibiting a percentage a/b×100% of the total light transmittance a at the center in the film width direction relative to the total light transmittance b on both end sides of about 10% to 95% can be provided. In the case where the total light transmittance is made uniform in the longitudinal direction of the film, the rate of change of the total light transmittance in the longitudinal direction of the film can be made 10% or less.

In the case where the total light transmittance is periodically varied in the longitudinal direction of the film, a film exhibiting a percentage c/d×100% of the lowest total light transmittance c at the center in the film width direction relative to the highest total light transmittance d of about 20% to 95% can be provided.

The materials and thicknesses of the mold release film 2, the adhesive layers 3 and 4, the base film 5, and the antireflection film 6 are not specifically limited. For example, the thickness of the mold release film 2 is 25 to 100 μm, the total thickness of the first adhesive layer 3 and the second adhesive layer 4 is 20 to 40 μm, the thickness of the base film 5 is 30 to 250 μm, and the thickness of the antireflection film 6 is 0.1 to 10 μm. However, the present invention is not specifically limited to them. The thickness of the central portion of the first adhesive layer 3 may be set at about 1.2 to 3 times the thickness of both end sides, although not limited to this. The colors of the adhesive layers 3 and 4 are not specifically limited. The width of the film 1 is set at, for example, 500 to 1,000 mm, although not limited to this.

Previously known various adhesives of, e.g., rubber base, acryl base, silicone base, and EVA base, can be used as the adhesive. A coloring matter added to the adhesive to adjust the total light transmittance of the adhesive layer is not specifically limited. Examples of pigments include inorganic pigments, e.g., carbon black, titanium oxide, chromium oxide, oxide yellow, red ion oxide, and ultramarine, and organic pigments, e.g., azo pigments, phthalocyanine pigments, anthracene pigments, threne pigments, and dioxazine pigments, although not limited to them.

An example of adhesives suitable for use in the film of the present invention is an adhesive containing a (meth)acrylic resin as a primary component and an epoxy compound as a cross-linking agent, wherein the (meth)acrylic resin contains 1 to 25 percent by weight of monomer component having a carboxyl group, as a copolymerization component of the alkyl(meth)acrylate.

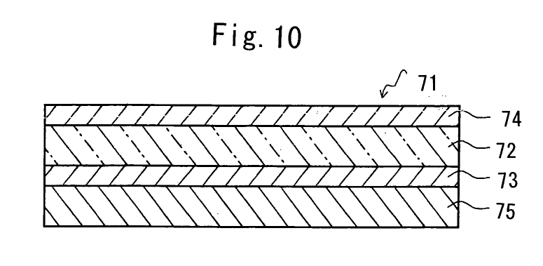

This suitable adhesive is the same as that of the adhesive layer 73 shown in FIG. 10 which will be described below.

Next, the materials for the mold release film 2 and the base film 5 will be described.

Examples of materials for these films 2 and 5 include cellulose films of triacetyl cellulose base, polycarbonate films, polyester films, e.g., polyethylene terephthalate, and polyolefin films, e.g., polyethylene and polypropylene, although not limited to them.

The film 1 of the present invention may include at least one of a hard coat layer, an electrically conductive layer, an antireflection layer, an antiglare layer, and the like.

The adhesive-including film in accordance with the present invention may be manufactured by mixing at least two formulations having different total light transmittances and applying the resulting mixture to a film immediately after the mixing so as to form (a film of) the adhesive layer.

This method is effective against not only variations in luminance, but also variations in color saturation, since the thickness of the adhesive layer is not varied in a surface and, in addition, toning can be performed on a formulation basis. In this method as well, the above-described film formation method can be used. For example, as for the T die method, when the supply of material is divided into three before extrusion, and the resulting three components are put in so that the total light transmittances become large-medium-small from the end, a film of the adhesive having a large-medium-small total light transmittance after film formation can be formed. When the resulting three components are put in so that the total light transmittances become small-large-small, a film of the adhesive having a small-large-small total light transmittance after film formation can be formed. The same holds true for the comma method. The total light transmittance and the quantity of supply of each material are controlled and, thereby, an adhesive having a total light transmittance being continuously varied in one desired direction can be produced. Since this method can independently change the toning of each material, an adhesive layer having not only a total light transmittance being continuously varied, but also a color saturation being continuously varied, can be produced.

In the above-described embodiment, the total light transmittance of the adhesive layer is varied and, thereby, the total light transmittance of the film is varied in a one-dimensional direction or a two-dimensional direction. However, in the present invention, the total light transmittance of the film may also be varied in a one-dimensional direction or a two-dimensional direction by varying the total light transmittance of the base film itself. In order to realize this, it is essential that the content of coloring matter or pigment in the film is made to have a distribution in the one-dimensional direction or the two-dimensional direction during film formation. This coloring matter or pigment may be, for example, the above-described coloring matter or pigment to be contained in the adhesive. Alternatively, the concentration of the coloring matter or pigment in the base film may be kept constant, and the total light transmittance of the film may be varied in a one-dimensional direction or a two-dimensional direction by varying the thickness of the base film.

In the present invention, a colored layer different from the adhesive layer may be disposed on the surface of the base film, and the total light transmittance of the film may be varied in a one-dimensional direction or a two-dimensional direction by varying the thickness or the color strength of this colored layer. This colored layer may be disposed only for the purpose of varying the total light transmittance, or may also serves as a functional layer, e.g., an antireflection layer, an antiglare layer, a hard coat layer, or an electrically conductive layer. When this colored layer is formed, preferably, a printing material containing a coloring matter or a pigment, is printed. This coloring matter or pigment may be similar to that contained in the above-described adhesive layer.

The present invention will be more specifically described below with reference to examples and comparative examples. However, the present invention is not limited to the following examples, and covers various modifications and the like included within the scope of the present invention.

### EXAMPLE 1

A flask was provided with a thermometer, an agitator, a reflux cooling pipe, and a nitrogen introduction pipe, and 68 parts by weight of n-butyl acrylate, 22 parts by weight of methyl acrylate, 10 parts by weight of acrylic acid, 0.1 parts by weight of azobisisobutylonitrile, 40 parts by weight of ethyl acetate, and 60 parts by weight of toluene were put therein. Nitrogen was introduced through the nitrogen introduction pipe and, thereby, the inside of the flask was brought into a nitrogen atmosphere. Thereafter, the resulting mixture was heated to 65° C. and a polymerization reaction was performed for 10 hours, so that an acrylic polymer solution having a weight average molecular weight of about 350,000 and Tg of about −25° C. was produced. Ethyl acetate was added to the acrylic polymer solution so that the solids content became 28 percent by weight and, therefore, a polymer solution A was produced.

A coating solution was prepared by blending 100 parts by weight of polymer solution A with 0.05 parts by weight of epoxy cross-linking agent (trimethylolpropane triglycidyl ether) and 2 parts by weight of pigment (CAB LX905 Black produced by TOYO INK MFG. CO., LTD.). The resulting coating solution was applied to a mold release PET film “DIAFOIL MRF38” (produced by Mitsubishi Polyester Film Corp.) having been subjected to a silicone treatment and having a thickness of 38 μm in a manner as shown in FIGS. 4A and 4B, followed by drying. The same coating solution as the above-described coating solution except that no pigment was included was further applied thereon, followed by drying. Furthermore, a PET film “OLW” (produced by Teijin DuPont Films Japan Limited) having a thickness of 175 μm was stuck thereon.

In this manner, an adhesive-layer-including film having the sectional configuration shown in FIG. 1 (although the antireflection layer 6 is not shown) was produced.

The thickness of the central portion of the adhesive layer 3 was 20 μm, and the thicknesses of both end sides of the film were 10 μm. The total thickness of the adhesive layer 3 and the adhesive layer 4 was 25 μm (constant).

The mold release PET film was peeled off this film. The resulting film was stuck to glass having a thickness of 3 mm, and the total light transmittance was measured. As a result, the total light transmittance of the film was 50% at the center in the width direction, and was 70% at both end sides.

As described above, according to the present invention, a film having a total light transmittance being varied in the film width direction is provided.

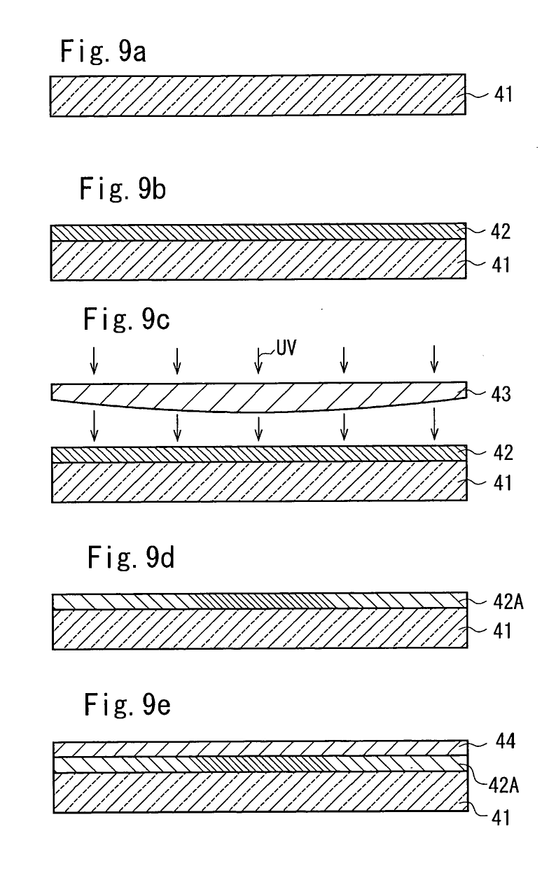

II. The embodiments of a dimmer film of the present invention and a manufacturing method therefor will be described below in detail with reference to FIGS. 9A to 9E.

In the production of the dimmer film, a colored layer 42 containing a dye which tends to be faded due to ultraviolet light B and has excellent heat resistance (hereafter may be referred to as “an easy-to-fade dye”) is formed on a base film 41 (FIGS. 9A and 9B).

Examples of materials for this base film 41 include cellulose films of triacetyl cellulose base; polycarbonate films; polyester films, e.g., polyethylene terephthalate; and polyolefin films, e.g., polyethylene and polypropylene, although not limited to them. Preferably, the thickness of the base film 41 is controlled at within the range of 25 to 250 μm since satisfactory strength is attained and the thickness of the dimmer film is not excessively increased.

The easy-to-fade dye to be blended into the colored layer 42 is not specifically limited. For example, “Kayaset Black G” and “Kayaset Black B” produced by Nippon Kayaku Co., Ltd., “Oil Colours”, “Black 141”, and “Oil Colours Black 6” produced by CHUO SYNTHETIC CHEMICAL CO., LTD., and the like can be used.

Preferably, the colored layer 42 is an adhesive layer. Previously known various adhesives of, e.g., rubber base, acryl base, silicone base, and EVA (ethylene-vinyl acetate) base, can be used as the adhesive to form the colored adhesive layer.

The content of the easy-to-fade dye in the colored layer 42, e.g., a colored adhesive layer, is not specifically limited. However, about 0.1 to 20 percent by weight is preferable. If the content of the easy-to-fade dye in the colored layer 42 is smaller than the above-described range, it is difficult to provide the colored layer with significant changes in color strength by fading through application of the ultraviolet light B. If the content of the easy-to-fade dye is larger than the above-described range, the film formation property and the like of the colored layer is deteriorated.

The thickness of this colored layer 42 is not specifically limited. However, about 0.01 to 30 μm is preferable. This is because if the thickness of this colored layer 42 is smaller than the above-described range, it is difficult to provide the colored layer with significant changes in color strength by fading through irradiation of the ultraviolet light B, and if the thickness of the colored layer 42 is larger than the above-described range, the thickness of the dimmer film is increased, and the fading becomes unsatisfactory.

This colored layer 42 can be formed by applying a predetermined thickness of adhesive composition containing a predetermined quantity of easy-to-fade dye to the base film.

The coating method is not specifically limited. Examples thereof can include a gravure coater, a bar coater, a roll coater, a knife coater, and a reverse roll coater. Preferably, the gravure coating method is adopted since the uniformity of the thickness is required.

This colored layer 42 is formed on the base film 41 with a uniform thickness and with uniform color strength.

After the colored layer 42 is formed, the colored layer 42 is irradiated with the ultraviolet light B through a mask 43 having an ultraviolet light B transmission quantity distribution in the surface direction and, thereby, the colored layer 42 is faded so that the color strength is varied in the surface direction (FIG. 9C).

In FIG. 9C, the mask 43 made of PET film is used. The thickness of the central portion of the mask 43 is larger than the thicknesses of both end portions, and the thickness is continuously varied from the central portion toward both end portions. As a result, the light transmission quantity is continuously decreased from the central portion toward both end portions so that the ultraviolet light B transmission quantity is decreased at the central portion and the ultraviolet light B transmission quantity is increased at both end portions.

The thickness of this mask 43 is appropriately determined in accordance with the irradiation quantity of light required for fading the colored layer 42. In general, the ultraviolet light B (310 nm) transmission quantity of the PET film is about 20% when the thickness is 10 μm, and is about 4.4% when the thickness is 20 μm. Consequently, the mask 43 is appropriately designed so that a predetermined light transmission quantity can be attained at a predetermined portion while the thickness is within the range of 5 to 30 μm.

The mask 43 shown in FIG. 9C can be produced by, for example, performing extrusion while a blade having an arch surface curved to become convex upward in the width direction is disposed at an extrusion hole in the extrusion of the film. Alternatively, the mask 43 can be produced by stacking and integrating very thin films, which are molded beforehand and have different areas, at predetermined portions so that predetermined thicknesses are attained.

The material for the mask is not limited to PET. It is essential only that the material for the mask has excellent ultraviolet light B resistance and the ultraviolet light B transmission quantity can be controlled. Quartz glass, fluororesins, and other resinous materials may be used. The material for the mask is not limited to the material in which the ultraviolet light B transmission quantity is varied by changing the thickness, and may be a material in which the ultraviolet light B transmission quantity is varied by changing the ultraviolet light B absorptive power in the surface direction of the mask.

The ultraviolet light B (wavelength 280 to 315 nm) can be applied through the above-described mask 43 by using a general ultraviolet light B lamp or metal halide lamp. Preferably, the output of this ultraviolet light B is about 80 to 300 W/cm from the viewpoint of the effect on fading the colored layer 42. However, the degree of fading of the colored layer 42 due to the ultraviolet light B is different depending on the application time of the ultraviolet light B and the distance between the colored layer and the lamp. Therefore, preferably, these conditions, as well as the output, are set appropriately.

In this manner, the easy-to-fade dye in the colored layer 42 is faded by applying the ultraviolet light B to the colored layer 42 through the mask 43 and, thereby, the color strength of the colored layer 42 is varied in the surface direction thereof.

In the case where the mask 43 shown in FIG. 9C is used, the quantity of application of the ultraviolet light B is small at the central portion of the colored layer 42, and the quantity of application of the ultraviolet light B is large at both end portions. As a result, the color strength of the colored layer 42A after being faded is continuously varied from the center toward both end portions so that the color strength is high at the central portion and the color strength is low at both end portions (FIG. 9D).

After the colored layer 42 is faded as described above, an adhesive layer 44 containing a pigment is formed on this faded colored layer 42A. The adhesive layer may be formed on the surface opposite to the colored layer of the base film.

Previously known various adhesives of, e.g., rubber base, acryl base, silicone base, and EVA base, can be used as the adhesive to form this adhesive layer 44. Examples of pigments include inorganic pigments, e.g., carbon black, titanium oxide, chromium oxide, oxide yellow, red ion oxide, and ultramarine, and organic pigments, e.g., azo pigments, phthalocyanine pigments, anthracene pigments, threne pigments, and dioxazine pigments, although not limited to them.

The content of the pigment in the adhesive layer 44 is not specifically limited. However, about 0.01 to 10 percent by weight is preferable. If the content of the pigment in the adhesive layer 44 is smaller than the above-described range, the effect on adjusting the transmitted color due to disposition of this adhesive layer 44 cannot be satisfactorily exerted. If the content of the pigment is larger than the above-described range, the film formation property and the like of the adhesive layer is deteriorated and, in addition, satisfactory adhesion cannot be attained.

The thickness of this adhesive layer 44 is not specifically limited. However, 5 to 50 μm is preferable. If the thickness of the adhesive layer 44 is smaller than the above-described range, the effect on adjusting the transmitted color due to disposition of this adhesive layer 44 cannot be adequately exerted. If the thickness of the adhesive layer 44 is larger than the above-described range, the thickness of the dimmer film is increased, and the productivity is deteriorated.

This adhesive layer 44 can be formed by applying a predetermined thickness of adhesive composition containing a predetermined quantity of pigment on the colored layer 42 or on the side opposite thereto. The coating method therefor is not specifically limited. Although a method similar to the coating method for the colored layer 42 can be adopted, a knife coater method is preferable since the viscosity of the coating solution is high.

Preferably, this adhesive layer 44 is formed on the colored layer 42 with a uniform thickness and with uniform color strength as well.

Usually, a mold release film is stuck to this adhesive layer 44. The material for this mold release film is similar to that for the above-described base film 41, and the thickness thereof is usually about 25 to 100 μm.

The thus produced dimmer film is most highly colored (the total light transmittance is low.) at the central portion, and becomes lightly colored with increasing proximity to both end sides. That is, the total light transmittance of the dimmer film is increased with increasing proximity to both end sides.

Consequently, in the case where the mold release film is peeled off and the dimmer film is stuck to a display, when variations in luminance of the display is in a pattern reverse to the distribution of light and dark of the dimmer film, the variations in luminance can be eliminated or reduced.

In the present invention, the dimmer film is basically composed of the base film 41, the faded colored layer 42A, preferably faded colored adhesive layer, and the adhesive layer 44, as shown in FIG. 9E. However, the mold release film may be disposed on the adhesive layer 44, as described above. An antireflection layer may be disposed on the surface opposite to the surface provided with the colored layer of the base film. In this case, preferably, the thickness of the antireflection layer is about 0.1 to 10 μm. The antireflection layer may be formed before the colored layer is formed. In addition, a hard coat layer, an electrically conductive layer, an antiglare layer, and the like may be included. The colored layer may also serve as these functional layers.

According to the present invention, for example, a film exhibiting a percentage a/b×100% of the total light transmittance a at the center relative to the total light transmittance b on both end sides of about 10% to 95% can be provided. The total light transmittance of this dimmer film may be varied one-dimensionally or two-dimensionally in the film surface direction. The design of the total light transmittance of the dimmer film can be arbitrarily changed by selecting the mask.

As for the dimmer film of the present invention, the colored layer disposed on the base film and containing the easy-to-fade dye is irradiated with the ultraviolet light B having a light quantity distribution in the surface direction so that the colored layer is faded and the color strength is varied in the surface direction. The adhesive layer containing the pigment is disposed and, thereby, the transmitted color of the faded colored layer is adjusted. The method for manufacturing the dimmer film is not limited to the method shown in FIGS. 9A to 9E.

For example, as shown in FIGS. 9A to 9C, the colored layer 42 containing the easy-to-fade dye is formed on the base film 41, the ultraviolet light B is applied through the mask 43 and, thereafter, the adhesive layer containing the pigment and disposed on the mold release film is stuck thereto, so that the dimmer film can be produced as well. Alternatively, it is also possible to form the colored layer and the adhesive layer on the base film and, thereafter, fade the colored layer by applying the ultraviolet light B through the mask, as shown in FIG. 9C. However, it is preferable to adopt the manufacturing method shown in FIGS. 9A to 9E on the ground that the state of fading of the colored layer is ascertained and, thereafter, the adhesive layer containing the pigment can be formed so that a desired transmitted color is attained.

An example of adhesives suitable for use in the dimmer film of the present invention is an adhesive containing a (meth)acrylic resin as a primary component and an epoxy compound as a cross-linking agent, wherein the (meth)acrylic resin contains 1 to 25 percent by weight of monomer component having a carboxyl group, as a copolymerization component of the alkyl(meth)acrylate.

This adhesive is the same as the adhesive used in the adhesive layer 73 which will be described below with reference to FIG. 10.

The dimmer film of the present invention and the manufacturing method therefor will be more specifically described below with reference to examples and comparative examples. However, the present invention is not limited to the following examples, and covers various modifications and the like included within the scope of the present invention.

### EXAMPLE 2

A dimmer film was produced by the method shown in FIGS. 9A to 9E.

A colored adhesive layer (thickness 8 μm) made of an acrylic adhesive (“Foret M-80” produced by Soken Chemical and Engineering Co., Ltd.) containing 5 percent by weight of an easy-to-fade dye, “Kayaset Black G” produced by Nippon Kayaku Co., Ltd., was formed by a gravure coating method on the surface of “O300” (thickness 100 μm) produced by Mitsubishi Polyester Film Corp., serving as the base film.

This colored adhesive layer is irradiated with the ultraviolet light B (output 80 W/cm) from a UV-B lamp “TL/12 lamp” produced by Philips Japan Ltd., at a distance of 40 cm for 60 minutes through the following mask and, thereby, the colored adhesive layer was faded.

Mask

A mask in which the thickness of the central portion was 25 μm, the thicknesses of both end portions were 60 μm, and the thickness was continuously varied from the central portion toward both end portions.

Subsequently, an adhesive layer (thickness 25 μm) was formed on the faded colored adhesive layer by using an acrylic adhesive (“2065M” produced by Soken Chemical and Engineering Co., Ltd.) containing 0.1 percent by weight of “CAB LX905” and 0.4 percent by weight of “CAB LX716”, each produced by TOYO INK MFG. CO., LTD., as a pigment.

The total light transmittance and the transmitted color of the thus produced dimmer film are shown in Table 1. A desired transmitted color was attained.

### COMPARATIVE EXAMPLE 1

A colored adhesive layer and an adhesive layer were formed as in Example 1 except that the ultraviolet light B was not applied. The total light transmittance and the transmitted color of the resulting film are shown in Table 1.

### COMPARATIVE EXAMPLE 2

A dimmer film was formed as in Example 1 except that the adhesive layer was not formed. The total light transmittance of the resulting film is shown in Table 1. The transmitted color was yellow and, therefore, any desired transmitted color was not attained.

TABLE 1

| | Total light transmittance | Transmitted color |
|---|---|---|
| Example 2 | central portion: 67%, both | gray, desired transmitted |
| | end portions: 85%, varying | color |
| | continuously | |
| Comparative | 65%, uniform | gray |
| example 1 | | |
| Comparative | central portion: 70%, both | central portion: gray, both |
| example 2 | end portions: 91%, varying | end portions: yellow, |
| | continuously | undesired transmitted color |

The dimmer film of the present invention can be effectively applied to liquid crystal displays of back light system or front light system, other displays, e.g., CRT, PDP, and FED, and in addition, display panels, e.g., electric bulletin boards, having light sources.

III. The embodiments of a display adhesive and a display functional film will be described below in detail with reference to FIG. 10. FIG. 10 is a sectional view showing an embodiment of a display functional film according to the present invention.

In a display functional film 71, an adhesive layer 73 made of the adhesive according to the present invention is disposed on one surface of a base film 72, a functional layer 74, e.g., a hard coat layer, an electrically conductive layer, an antiglare layer, or an antireflection layer, is disposed on the other surface, and a mold release film 75 is disposed on the adhesive layer 73.

The display adhesive of the present invention, used for the above-described display functional film 71 of the present invention will be described below.

The display adhesive of the present invention contains a (meth)acrylic resin as a primary component and an epoxy compound as a cross-linking agent, wherein the (meth)acrylic resin contains 1 to 25 percent by weight of monomer component having a carboxyl group, as a copolymerization component of the alkyl(meth)acrylate.

Examples of alkyl(meth)acrylates constituting the (meth)acrylic resin according to the present invention include alkyl esters of acrylic acid or methacrylic acid having an alkyl group, e.g., a methyl group, an ethyl group, an isopropyl group, a n-butyl group, an isobutyl group, an isoamyl group, a hexyl group, a heptyl group, a cyclohexyl group, a 2-ethylhexyl group, an isooctyl group, an isononyl group, a lauryl group, a dodecyl group, an isomyristyl group, and an octadecyl group. These may be used alone or in combination.

Examples of monomer components having a carboxyl group include (meth)acrylic acid; carboxyalkyl(meth)acrylates, e.g., carboxyethyl(meth)acrylate and carboxypentyl(meth)acrylate; itaconic acid; maleic acid; and crotonic acid. These may be used alone or in combination.

The (meth)acrylic resin may contain other copolymerization components in addition to the above-described alkyl(meth)acrylate and a monomer component having a carboxyl group. Examples of other usable copolymerization components include maleimide monomers, e.g., N-cyclohexylmaleimide, N-isopropylmaleimide, N-laurylmaleimide, and N-phenylmaleimide; itaconimide monomers, e.g., N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers, e.g., N-(meth)acryloyloxymethylenesuccinimide, N-(meth)acryloyl-6-oxyhexamethylenesuccinimide, and N-(meth)acryloyl-8-oxyoctamethylenesuccinimide; sulfonic-acid-containing monomers, e.g., 2-acrylamide-2-methylpropanesulfonic acid; phosphoric-acid-containing monomers, e.g., 2-hydroxyethylacryloylphosphate; vinyl monomers, e.g., vinyl acetate and styrene; divinyl monomers, e.g., divinylbenzene; diacrylate monomers, e.g., 1,4-butyl diacrylate and 1,6-hexyl diacrylate; acrylic acid ester monomers, e.g., tetrahydrofurfuryl(meth)acrylate, polyethylene glycol(meth)acrylate, polypropylene glycol(meth)acrylate, fluorinated (meth)acrylate, and silicone(meth)acrylate; alkoxy-containing monomers, e.g., trimethoxysilylpropyl acrylate; acid anhydride monomers, e.g., maleic anhydride and itaconic anhydride; and other compounds, e.g., hexanediol di(meth)acrylate, (poly)ethylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy acrylate, polyester acrylate, and urethane acrylate.

Monomer components having a functional group other than the carboxylic group can also be used. Examples of monomers having a functional group include hydroxyl-containing monomers, e.g., 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl acrylate; epoxy-containing monomers, e.g., glycidyl (meth)acrylate; and amide monomers, e.g., (meth)acrylamide, N-acryloylmorpholine, N-substituted (meth)acrylamide, and N-vinylpyrrolidone.

If the content of monomer component containing a carboxyl group in the (meth)acrylic resin is smaller than 1 percent by weight, the adhesion to a display panel made of, e.g., glass, is lowered. If the content exceeds 25 percent by weight, the glass transition temperature Tg of the adhesive tends to be increased, so that satisfactory tackiness cannot be attained. Therefore, it is preferable that the content of monomer component containing a carboxyl group is 1 to 25 percent by weight, in particular, 5 to 20 percent by weight.

Preferably, the content of alkyl(meth)acrylate which is a primary component of the (meth)acrylic resin is 50 percent by weight or more, in particular, 60 percent by weight or more in order to ensure the optical properties as the (meth)acrylic resin.

The (meth)acrylic resin according to the present invention is produced from an alkyl(meth)acrylate, a monomer component having a carboxyl group, and other copolymerization components used as required by polymerizing these monomer components through a common polymerization system, e.g., solution polymerization, emulsion polymerization, bulk polymerization, or suspension polymerization. In this polymerization, a thermal polymerization initiator or a photopolymerization initiator is used. Alternatively, potassium persulfate, ammonium persulfate, hydrogen peroxide, a redox initiator in which the above-described compound and a reducing agent are used in combination, or the like is used.

Among the polymerization initiators, examples of thermal polymerization initiators include organic peroxides, e.g., benzoyl peroxide, t-butyl perbenzoate, cumene hydroperoxide, diisopropyl peroxydicarbonate, di-n-propyl peroxydicarbonate, di(2-ethoxyethyl) peroxydicarbonate, t-butyl peroxyneodecanoate, t-butyl peroxypivalate, (3,5,5-trimethylhexanoyl) peroxide, dipropionyl peroxide, and diacetyl peroxide; and azo compounds, e.g., 2,2′-azobisisobutylonitrile, 2,2′-azobis(2-methylbutylonitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate), 4,4′-azobis(4-cyanovaleric acid), 2,2′-azobis(2-hydroxymethylpropionitrile), and 2,2′-azobis[2-(2-imidazoline-2-yl)propane].

Examples of photopolymerization initiators include acetophenone initiators, e.g., 4-(2-hydroxyethoxy)phenyl(2 -hydroxy-2-propyl) ketone, α-hydroxy-α,α′-dimethylacetophenone, methoxyacetophenone, 2,2-dimethoxy-2-phenylacetophenone, 1-hydroxycyclohexylphenyl ketone, and 2-methyl-1-[4-(methylthio)-phenyl]-2-morpholinopropane-1; benzoin ether initiators, e.g., benzoyl ethyl ether and benzoin isopropyl ether; ketal initiators, e.g., benzyl methyl ketal; benzophenone initiators, e.g., benzophenone, benzoylbenzoic acid, and 3,3′-dimethyl-4-methoxybenzophenone; and thioxanthone initiators, e.g., thioxanthone, 2-chlorothioxane, 2-methylthioxanthone, 2,4-dimethylthioxanthone, isopropylthioxanthone, 2,4-dicyclothioxanthone, 2,4-diethylthioxanthone, and 2,4-diisopropylthioxanthone. In addition, camphorquinone, halogenated ketone, acylphosphinoxide, acylphosphonate, and the like can also be used.

The usage of the polymerization initiator is not specifically limited. However, preferably, the usage is usually 0.001 to 5 percent by weight relative to the monomer component to be used.

Preferably, the weight average molecular weight of the (meth)acrylic resin is 500,000 to 2,000,000. If the weight average molecular weight of the (meth)acrylic resin is smaller than 500,000, the heat resistance to 120° C. or more is deteriorated. If the weight average molecular weight exceeds 2,000,000, the synthesis takes significantly much time and, in addition, the viscosity of the adhesive solution becomes very high, so that the productivity, e.g., the workability of coating, is deteriorated.

The cross-linking agent contained in the adhesive is an epoxy compound. The epoxy cross-linking agent may be ethylene glycol diglycidyl ether, propylene glycol diglycidyl ether, diglycidyl ether, trimethylolpropane triglycidyl ether, or the like. These may be used alone or in combination.

If the content of the epoxy cross-linking agent is too small, the effect on improving the adhesion due to compounding the epoxy cross-linking agent is not satisfactorily exerted. If the content is too large, significant shrinkage is effected by cross-linking and, thereby, the film may be warped. Therefore, it is preferable that the content is 0.5 to 50 percent by weight relative to the monomer component having a carboxyl group in the (meth)acrylic resin.

Cross-linking agents other than the epoxy cross-linking agent may be contained. Examples of the above-described cross-linking agents include multifunctional isocyanate cross-linking agents, e.g., tolylene diisocyanate, trimethylolpropane tolylene diisocyanate, and diphenylmethane tolylene diisocyanate; melamine resin cross-linking agents; metal salt cross-linking agents; metal chelate cross-linking agents, and amino resin cross-linking agents. Preferably, the total content of the above-described epoxy cross-linking agent and the cross-linking agents other than the epoxy cross-linking agent is 10 percent by weight or less relative to the (meth)acrylic resin.

With respect to some displays which have been developed in recent years, the hue, the lightness, and the color saturation of the light from the display are adjusted by functional light transmission films. In some cases, adhesive layers are provided with this adjustment function. Therefore, a dye or pigment can be added to the adhesive of the present invention in order to provide such a function. The pigment is used preferably as compared with the dye from the viewpoint of the durability. Examples of pigments having excellent compatibility with the adhesive of the present invention include CAB pigments produced by TOYO INK MFG. CO., LTD. It is possible to perform desired toning by using them alone or in combination. The adhesive of the present invention may be blended with additives, e.g., ultraviolet absorbers, conductivity-imparting agents, oxidation inhibitors, antioxidants, natural and synthetic resins, glass fibers, and glass beads within the range in which the transparency is not impaired. Fine particles may be blended to provide the adhesive with the light diffusion property.

In order to form the adhesive layer 73 of the display functional film 71, for example, a (meth)acrylic resin as a primary component of the adhesive may be dissolved or dispersed in an appropriate organic solvent, e.g., toluene and ethyl acetate, so as to prepare a solution containing about 10 to 40 percent by weight of adhesive, an epoxy cross-linking agent may be further added thereto, followed by agitating. Thereafter, the resulting solution may be applied by a flow casting method or a coating method to one surface of the base film 72, followed by drying. Alternatively, the above-described solution containing the adhesive may be applied to a separator (mold release film 75), and be dried so as to form the adhesive layer 73. Subsequently, this may be stuck to the base film 72.

The thickness of the adhesive layer 73 disposed in the display functional film 71 is not specifically limited. However, in general, it is preferable that the adhesive layer 73 is formed to have a thickness of about 5 to 50 μm.

The base film 72 of the display functional film 71 is not specifically limited. However, a base film having optical transparency is used preferably. Examples of preferable films used as the base film include cellulose films made of, e.g., triacetyl cellulose; polycarbonate films; polyester films made of, e.g., polyethylene terephthalate (PET); and polyolefin films made of, e.g., polyethylene and polypropylene, from the viewpoint of optical properties, strength, economy, and the like. In general, it is preferable that the thickness thereof is about 30 to 300 μm from the viewpoint of the strength, reduction in thickness, and the like.

Examples of functional layers 74 to be disposed on the base film 72 include at least one of a hard coat layer, a transparent electrically conductive layer, an antiglare layer, an antireflection layer, and the like, although not limited to them.

A hard sheet, e.g., a glass sheet, an acrylic sheet, or a polycarbonate sheet, having a thickness of about 1 to 10 mm is used as a display panel to which the display functional film is stuck. However, the material and the thickness are not specifically limited.

The adhesive and the display film of the present invention will be more specifically described below with reference to examples and comparative examples. However, the present invention is not limited to the following examples, and covers various modifications and the like included within the scope of the present invention.

### EXAMPLE 3

A flask was provided with a thermometer, an agitator, a reflux cooling pipe, and a nitrogen introduction pipe, and 68 parts by weight of n-butyl acrylate, 22 parts by weight of methyl acrylate, 10 parts by weight of acrylic acid, 0.1 parts by weight of azobisisobutylonitrile, 40 parts by weight of ethyl acetate, and 60 parts by weight of toluene were put therein. Nitrogen was introduced through the nitrogen introduction pipe and, thereby, the inside of the flask was brought into a nitrogen atmosphere. Thereafter, the resulting mixture was heated to 65° C. and a polymerization reaction was performed for 10 hours, so that an acrylic polymer solution having a weight average molecular weight of about 350,000 and Tg of about −25° C. was produced. Ethyl acetate was added to the acrylic polymer solution so that the solids content became 28 percent by weight and, therefore, a polymer solution A was produced.

A coating solution was prepared by blending 100 parts by weight of polymer solution A with 0.05 parts by weight of epoxy cross-linking agent (trimethylolpropane triglycidyl ether). The resulting coating solution was applied to a mold release PET film “DIAFOIL MRF38” (produced by Mitsubishi Polyester Film Corp.) having been subjected to a silicone treatment and having a thickness of 38 μm, followed by drying. A PET film “OLW” (produced by Teijin DuPont Films Japan Limited) having a thickness of 175 μm was stuck thereto.

The mold release PET film was peeled off this film. The resulting film was stuck to glass having a thickness of 3 mm to prepare a measurement sample. The adhesion and the degree of discoloration were evaluated by the following methods. The results are shown in Table 2.

<Adhesion>

The above-described measurement sample was stood for 500 hours in an atmosphere at a temperature and a humidity shown in Table 2 and, thereafter, the adhesion relative to 180-degree peeling was measured in conformance with JIS Z-0237.

<Degree of Discoloration>

The above-described measurement sample was stood for 500 hours in an atmosphere at a temperature and a humidity shown in Table 2 and, thereafter, the color difference ΔE from the initial state with a two-degree-field D65 light source was measured in conformance with JIS Z-8730.

### COMPARATIVE EXAMPLE 3

The polymerization reaction was performed as in Example 3 except that 65 parts by weight of n-butyl acrylate, 20 parts by weight of methyl acrylate, 15 parts by weight of acrylic acid-2-hydroxyethyl ester, 0.1 parts by weight of azobisisobutylonitrile, 40 parts by weight of ethyl acetate, and 60 parts by weight of toluene were put in the flask, so that an acrylic polymer solution having a weight average molecular weight of about 750,000 and Tg of about −23° C. was produced. Ethyl acetate was added to the acrylic polymer solution so that the solids content became 28 percent by weight and, therefore, a polymer solution B was produced.

An adhesive layer was formed as in Example 3 except that 0.1 parts by weight of tolylene diisocyanate was added to 100 parts by weight of this polymer solution B. The adhesion and the degree of discoloration were evaluated as in the above description. The results are shown in Table 2.

TABLE 2

| | Atmosphere | | | |
|---|---|---|---|---|
| | Temperature | Humidity | | Comparative |
| | (° C.) | (% RH) | Example 3 | example 3 |
| Adhesion | 23 | 40 | 3000 | 2000 |
| (gf/25 mm) | 100 | Dry | 3300 | 2300 |
| | 120 | Dry | 3300 | 700 |
| | 60 | 90 | 3000 | 100 |
| Degree of | 100 | Dry | 0.22 | 0.72 |
| discoloration | 120 | Dry | 0.71 | 2.40 |
| (ΔE) | | | | |

As is clear from Table 2, the adhesive of the present invention has high adhesion, and the adhesion and the optical properties exhibit excellent high-temperature durability and high-humidity durability.

As described above in detail, the display adhesive of the present invention has high adhesion to a display panel and the adhesion and the optical properties exhibit excellent high-temperature durability and high-humidity durability. Consequently, the display functional film of the present invention provided with the adhesive layer made of the display adhesive of the present invention can stably maintain excellent adhesion and transparency for the long term without occurrence of deterioration, e.g., peeling and yellowing, in the use for various electronic display panels.

1. A film having a light transmission property, wherein the total light transmittance is varied in a transverse direction of the film.

2. The film according to claim 1, wherein the total light transmittance of the central portion in the transverse direction of the film is lower than those of both end sides.

3. The film according to claim 1, wherein the distribution of the total light transmittance in the direction orthogonal to the transverse direction of the film is uniform.

4. The film according to claim 1, wherein the total light transmittance is varied periodically in the direction orthogonal to the transverse direction of the film.

5. The film according to claim 1, comprising a base film and an adhesive layer disposed on the base film.

6. The film according to claim 5, wherein the adhesive layer is a colored layer.

7. The film according to claim 6, wherein the total light transmittance is varied with changes in the thickness of the adhesive layer.

8. The film according to claim 6, wherein the total light transmittance is varied with changes in the color strength of the adhesive layer.

9. An adhesive-including film according to claim 5, wherein the adhesive layer comprises a colored first adhesive layer and a colorless or light-colored second adhesive layer, the second adhesive layer being light-colored as compared with the first adhesive layer, and the total light transmittance is varied with changes in the thickness of the first adhesive layer.

10. The adhesive-including film according to claim 9, wherein the total thickness of the first adhesive layer and the second adhesive layer is uniform all over the film.

11. The film according to claim 1, wherein the film is a colored base film.

12. The film according to claim 5, wherein the total light transmittance is varied with changes in the thickness of the base film.

13. The film according to claim 5, wherein the total light transmittance is varied with changes in the color strength of the base film.

14. The film according to claim 1, comprising a base film and a colored layer disposed on the base film,
wherein the total light transmittance of the film having a light transmission property is varied with changes in the total light transmittance of the colored layer.

15. The film according to claim 14, wherein the total light transmittance of the film having a light transmission property is varied with changes in the thickness of the colored layer.

16. The film according to claim 14, wherein the total light transmittance of the film having a light transmission property is varied with changes in the color strength of the colored layer.

17. The film according to claim 14, wherein the colored layer is a printed layer.

18. The film according to claim 14, wherein the colored layer is a part of an antireflection layer, a hard coat layer, an antiglare layer, or an electrically conductive layer.

19. A method for manufacturing an adhesive-including film, including the step of supplying an adhesive on a film surface to form an adhesive layer on the film surface while the film is continuously forwarded, the method comprising the step of:
forming the adhesive layer so that the thickness of the adhesive layer is varied in a film width direction orthogonal to the forwarding direction of the film.

20. The method for manufacturing an adhesive-including film according to claim 19, comprising the step of:
forming the adhesive layer by leveling the adhesive on the film surface with a blade,
wherein the clearance between the blade and the film surface is varied in the width direction.

21. The method for manufacturing an adhesive-including film according to claim 20, wherein the clearance between the blade and the film surface is periodically varied with time.

22. The method for manufacturing an adhesive-including film according to claim 21, wherein the clearance between the blade and the film surface is periodically varied with time by shaking the blade in the forwarding direction of the film.

23. A dimmer film including a base film, a colored layer disposed on the base film, and an adhesive layer disposed on the colored layer and having a light transmission property with a total light transmittance being varied in a surface direction due to changes in the color strength of the colored layer in the surface direction,
wherein the colored layer contains a heat-resistant dye readily fading due to ultraviolet light B,
the colored layer has been faded by being irradiated with the ultraviolet light B having a light quantity distribution in the surface direction so that the color strength is varied in the surface direction, and
the adhesive layer contains a pigment.

24. A method for manufacturing a dimmer film including a base film, a colored layer disposed on the base film, and an adhesive layer disposed on the colored layer and having a light transmission property with a total light transmittance being varied in a surface direction of the film, the method comprising the steps of:
forming the colored layer on a substrate, the colored layer containing a heat-resistant dye readily fading due to ultraviolet light B, in a first step;
irradiating the colored layer with the ultraviolet light B through a mask having an ultraviolet light B transmission quantity distribution in the surface direction so that the colored layer is faded and the color strength is varied in the surface direction, in a second step; and thereafter,
forming the adhesive layer on the colored layer, the adhesive layer containing a pigment, in a third step.

25. The method for manufacturing a dimmer film according to claim 24, wherein the mask comprises a polyethylene terephthalate film and exhibits the light transmission quantity distribution due to changes in the thickness in the surface direction.

26. The method for manufacturing a dimmer film according to claim 24, wherein the colored layer is a colored adhesive layer.

27. The method for manufacturing a dimmer film according to claim 24, wherein the total light transmittance of the central portion in the transverse direction of the dimmer film is lower than those of both end sides.

28. The method for manufacturing a dimmer film according to claim 24, wherein the distribution of total light transmittance in the direction orthogonal to the transverse direction of the dimmer film is uniform.

29. The method for manufacturing a dimmer film according to claim 24, wherein the total light transmittance is varied in the direction orthogonal to the transverse direction of the dimmer film.

30. The method for manufacturing a dimmer film according to claim 24, wherein the colored layer is formed by gravure coating.

31. The method for manufacturing a dimmer film according to claim 24, wherein the colored layer is a part of an antireflection layer, a hard coat layer, an antiglare layer, or an electrically conductive layer.

32. A dimmer film manufactured by the method for manufacturing a dimmer film according to claim 24.

33. A display adhesive comprising a (meth)acrylic resin as a primary component and a cross-linking agent,
wherein the (meth)acrylic resin contains 1 to 25 percent by weight of monomer component having a carboxyl group, as a copolymerization component of the alkyl (meth)acrylate, and
the cross-linking agent is an epoxy compound.

34. The display adhesive according to claim 33, wherein the weight average molecular weight of the (meth)acrylic resin is 500,000 to 2,000,000.

35. The display adhesive according to claim 33, wherein the monomer component having a carboxyl group is at least one selected from the group consisting of (meth)acrylic acid, carboxyethyl(meth)acrylate, carboxypentyl(meth)acrylate, itaconic acid, maleic acid, and crotonic acid.

36. The display adhesive according to claim 33, wherein the content of the cross-linking agent is 0.5 to 50 percent by weight relative to the monomer component having a carboxyl group.

37. A display functional film, in which an adhesive layer comprising the display adhesive according to claim 33 is disposed on one surface of a base film.

38. The display functional film according to claim 37, wherein at least one selected from the group consisting of a hard coat layer, a transparent electrically conductive layer, an antiglare layer, and an antireflection layer is disposed on the other surface of the base film.
